(19) United States
(12) Patent Application Publication
(10) Pub. No.: US 2017/0064603 A1
(43) Pub. Date: Mar. 2, 2017

(54) DYNAMIC SLACK TIME OPTIMIZATION

(71) Applicant: QUALCOMM Incorporated, San Diego, CA (US)

(72) Inventors: Vidya Sagar Putta, San Diego, CA (US); Stanley Tsai, Frederick, CO (US); Sundararaman Kunchithapatham, Boulder, CO (US); Ahmed Ali, San Diego, CA (US); Kamalakar Ganti, San Diego, CA (US); Jayesh Bathija, San Diego, CA (US); Ammar Kitabi, San Diego, CA (US); Praveen Appani, San Diego, CA (US)

(21) Appl. No.: 14/838,233

(22) Filed: Aug. 27, 2015

(51) Int. Cl. H04W 36/24; H04W 36/34; H04W 60/00

(52) U.S. Cl. CPC H04W 36/24; H04W 60/005; H04W 36/34; H04W 88/06

(57) ABSTRACT

A method for providing variable padding for tune away on a mobile communication device includes: performing a first tune away to a first radio access technology (RAT) on a first subscription; determining a status of a second RAT on a second subscription based on activities performed by the second RAT during a time period prior to the first tune away; determining padding for a second tune away to the first RAT based on the determined status of the second RAT; and causing the first RAT on the first subscription to wake up before a next page slot boundary by an amount of time equal to the padding.

### BACKGROUND

For successful page decoding, every radio access technology (RAT) of a multi-subscriber identity module (SIM) multi-standby (MSMS) or multi-SIM multi-active (MSMA) mobile communication device should be ready with set-up activities (e.g., radio frequency (RF) chain warm up, receiver finger assignment, etc.) completed before the paging slot boundary occurs. Due to processor speed limitation and processor instruction allocation to various activities of multiple RATs of a multi-SIM (MS) mobile communication device, RATs in sleep mode need extra time during wake up for page decoding, otherwise a RAT may fail to monitor the page from the beginning of the slot boundary. As a result, page misses may occur.

Since most modems are multi-mode modems, processor instructions are shared among multiple RATs. The page miss problem may occur more frequently with concurrent RATs (i.e., MSMA mobile communication devices).

To address the page miss problem, extra time (i.e., padding) may be added before wake up time for a RAT that is attempting page decoding to enable the RAT to complete the set-up activities (e.g., chain warm up, receiver finger assignment, etc.) necessary for page decoding by the time the RAT wakes up for slot boundary.

If the other RATs are not in a traffic state, the other RATs do not use much of the processor resources; therefore, the RAT waking up to decode a page may not require the extra time provided by the fixed padding to complete the set-up activities for page decoding. On the other hand, if extra time is not added (i.e., no padding) when the other RATs move to traffic state, wake up for a RAT attempting page decoding may be delayed causing page decoding failure for the RAT.

### SUMMARY

Apparatuses and methods for implementing variable padding for tune away are provided.

According to various embodiments there is provided a method for providing variable padding for tune away on a mobile communication device. In some embodiments, the method may include: performing a first tune away to a first radio access technology (RAT) on a first subscription; determining a status of a second RAT on a second subscription based on activities performed by the second RAT during a time period prior to the first tune away; determining padding for a second tune away to the first RAT based on the determined status of the second RAT; and causing the first RAT on the first subscription to wake up before a next page slot boundary by an amount of time equal to the padding.

According to various embodiments there is provided a mobile communication device. In some embodiments, the mobile communication device may include: a communication unit and a control unit.

The communication unit may be configured to communicate with a plurality of communication networks using a plurality of radio access technologies (RATs). The a control unit may be configured to: cause the communication unit to perform a first tune away to a first radio access technology (RAT) on a first subscription; determine a status of a second RAT on a second subscription based on activities performed by the second RAT during a time period prior to the first tune away; determine padding for a second tune away to the first RAT based on the determined status of the second RAT; and cause the first RAT on the first subscription to wake up before a next page slot boundary by an amount of time equal to the padding.

According to various embodiments there is provided a method for determining padding for tune away on a mobile communication device. In some embodiments, the method may include: before transitioning a first radio access technology (RAT) to sleep mode after a first tune away, determining a status of a second RAT on a second subscription based on the activities performed by the second RAT during a time period prior to the first tune away; in response to determining that the status of the second RAT is a first status, determining a minimum padding for a second tune away to the first RAT; and causing the first RAT on the first subscription to wake up before a next page slot boundary by an amount of time equal to the minimum padding.

According to various embodiments there is provided a mobile communication device. In some embodiments, the mobile communication device may include: a communication unit and a control unit.

The communication unit may be configured to communicate with a plurality of communication networks using a plurality of radio access technologies (RATs). The a control unit may be configured to: before transitioning a first radio access technology (RAT) to sleep mode after a first tune away, determine a status of a second RAT on a second subscription based on activities performed by the second RAT during a time period prior to the first tune away; in response to determining that the status of the second RAT is a first status, determine a minimum padding for a second tune away to the first RAT; and cause the first RAT on the first subscription to wake up before a next page slot boundary by an amount of time equal to the minimum padding.

Other features and advantages of the various embodiments should be apparent from the following description which illustrates by way of example aspects of the various embodiments.

### BRIEF DESCRIPTION OF THE DRAWINGS

Aspects and features of the various embodiments will be more apparent by describing example embodiments with reference to the accompanying drawings, in which:

FIG. 1A is a block diagram illustrating a mobile communication device according to various embodiments;

FIG. 1B is a diagram illustrating a network environment for various embodiments;

FIG. 2 is a table illustrating padding for a first RAT on a first subscription based on the status of a second RAT on a second subscription according to various embodiments;

FIG. 3 is a diagram illustrating examples of padding added to wake up time for a RAT according to various embodiments;

FIG. 4 is a flowchart illustrating a method for applying padding according to various embodiments; and

FIG. 5 is a flowchart illustrating a method for determining padding according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

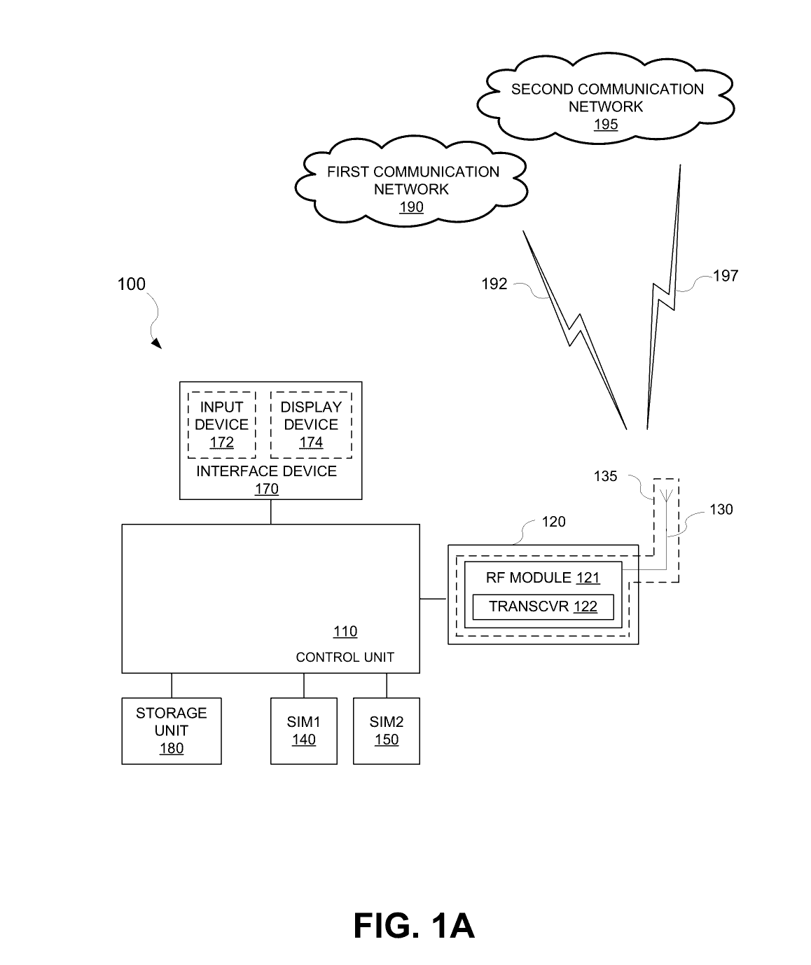

FIG. 1A is a block diagram illustrating a mobile communication device 100 according to various embodiments. As illustrated in FIG. 1A, the mobile communication device 100 may include a control unit 110, a communication unit 120, an antenna 130, a first SIM 140, a second SIM 150, a user interface device 170, and a storage unit 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communication units) and may interface with one or more antennas without departing from the scope of protection.

The communication unit 120 may include, for example, but not limited to, an RF module 121. The RF module 121 may include, for example, but not limited to a first transceiver 122. An RF chain 135 may include, for example, but not limited to the antenna 130 and the RF module 121.

One of ordinary skill in the art will appreciate that embodiments of the mobile communication device 100 may include more than one communication unit and/or more than one antenna without departing from the scope of protection.

A SIM (for example the first SIM 140 and/or the second SIM 150) in various embodiments may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 140 may associate the communication unit 120 with a first subscription (Sub1) 192 associated with a first radio access technology (RAT) on a first communication network 190 and the second SIM 150 may associate the communication unit 120 with a second subscription (Sub2) 197 associated with a second RAT on a second communication network 195. When a RAT is active, the communication unit 120 receives and transmits signals on the active RAT. When a RAT is idle, the communication unit 120 receives but does not transmit signals on the idle RAT.

For convenience, the various embodiments are described in terms of dual SIM dual standby (DSDS) mobile communication devices. However, one of ordinary skill in the art will appreciate that the various embodiments may be extended to Multi-SIM Multi-Standby (MSMS) and/or Multi-SIM Multi-Active (MSMA) mobile communication devices without departing from the scope of protection.

The first communication network 190 and the second communication network 195 may be operated by the same or different service providers, and/or may support the same or different RATs, for example, but not limited to, GSM, CDMA, wideband CDMA (WCDMA), Time Division-Synchronous Code Division Multiple Access (TD-SCDMA), and long term evolution (LTE).

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various embodiments.

The control unit 110 may be configured to control overall operation of the mobile communication device 100 including control of the communication unit 120, the user interface device 170, and the storage unit 180. The control unit 110 may be a programmable device, for example, but not limited to, a microprocessor (e.g., general-purpose processor, baseband modem processor, etc.) or microcontroller.

The storage unit 180 may be configured to store operating systems and/or application programs for operation of the mobile communication device 100 that are executed by the control unit 110, as well as to store application data and user data.

FIG. 1B is a diagram illustrating a network environment 105 for various embodiments. Referring to FIGS. 1A and 1B, the mobile communication device 100 may be configured to communicate with a first communication network 190 on a first subscription 192 and a second communication network 195 on a second subscription 197. One of ordinary skill in the art will appreciate that the mobile communication device 100 may configured to communicate with more than two communication networks and may communicate on more than two subscriptions without departing from the scope of protection.

The first communication network 190 and the second communication network 195 may implement the same or different radio access technologies (RATs). For example, the first communication network 190 may be a GSM network and the first subscription 192 may be a GSM subscription. The second communication network 195 may also be a GSM network. Alternatively, the second communication network 195 (and/or the first communication network 190) may implement another RAT including, for example, but not limited to, LTE, WCDMA, and Time Division-Synchronous Code Division Multiple Access (TD-SCDMA).

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the various embodiments.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

A first RAT on a subscription (e.g., Sub1 192) in idle mode on a multi-SIM mobile communication device (e.g., the mobile communication device 100) may wake up on a page slot boundary to receive a page from a network (e.g., the first communication network 190 or the second communication network 195). In order to receive the page, the control unit 110 may reconfigure the communication unit 120 (e.g., the RF chain 135) from performing activities of a second RAT on a second subscription (e.g., Sub2 197) to receive the page on Sub1 195. The control unit 110 may take an amount of time to reconfigure the communication unit 120.

However, if the control unit 110 uses additional time to perform activities for the second RAT on Sub2 197, the control unit 110 may not reconfigure the communication unit 120 in time for the first RAT on Sub1 192 to successfully receive and decode the page. Various embodiments may provide a variable amount of additional time (i.e., padding) before a page slot boundary to permit the control unit 110 to wake up the first RAT on Sub1 192 and reconfigure the communication unit 120 to receive a page on Sub1 192. The padding may be based on the status of the second RAT on Sub 2 197.

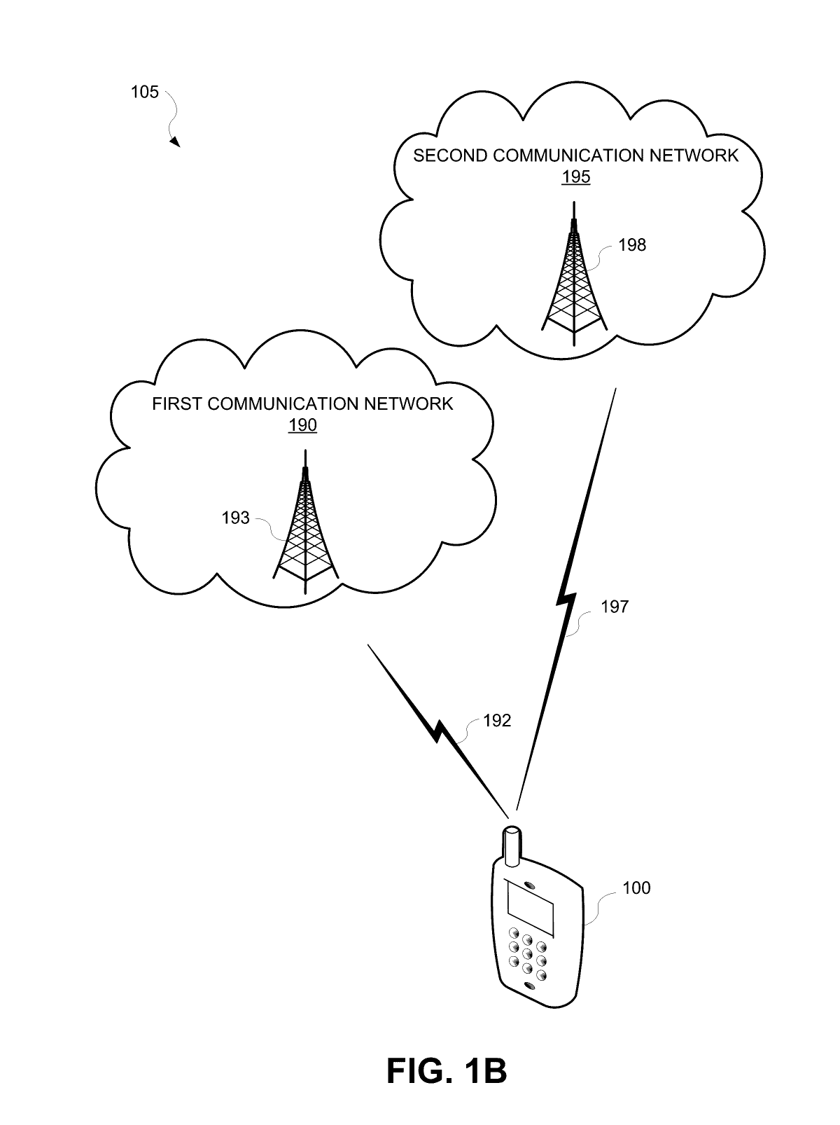

FIG. 2 is a table 200 illustrating padding for the first RAT on a first subscription (e.g., Sub1 192 in FIGS. 1A-1B) based on the status of a second RAT on a second subscription (e.g., Sub2 197 in FIGS. 1A-1B). Table 1 may correlate padding values with statuses of the second RAT. With reference to FIGS. 1A-2, according to Table 1, when the status of the second RAT on Sub2 197 is inactive (i.e., not camped on a network), no padding may be used for the control unit 110 to wake up the first RAT on Sub1 192 and reconfigure the communication unit 120. When the second RAT on Sub2 197 is in idle mode (i.e., status=idle), minimum padding of X milliseconds (ms) may be applied to cause the control unit 110 to wake up the first RAT on Sub1 192 X milliseconds before the page slot boundary occurs. The padding X may be more than the padding when Sub2 197 is inactive.

When the second RAT on Sub2 197 is receiving background traffic (e.g., packet switched (PS) user data traffic) without using receive diversity (i.e., status=background traffic without receive diversity), additional padding of A milliseconds added to the minimum padding of X milliseconds (i.e., X+A ms) may be applied to cause the control unit 110 to wake up the first RAT on Sub1 192 X+A milliseconds before the page slot boundary occurs.

Similarly, when the second RAT on Sub2 197 is receiving background traffic using receive diversity (i.e., status=background traffic with receive diversity), additional padding of B milliseconds added to the minimum padding of X milliseconds (i.e., X+B ms) may be applied to cause the control unit 110 to wake up the first RAT on Sub1 192 X+B milliseconds before the page slot boundary occurs.

Finally, when the second RAT on Sub2 197 is communicating with a network (e.g., the first communication network 190 or the second communication network 195) using carrier aggregation (i.e., status=carrier aggregation), additional padding of C milliseconds added to the minimum padding of X milliseconds (i.e., X+C ms) may be applied to cause the control unit 110 to wake up the first RAT on Sub1 192 X+C milliseconds before the page slot boundary occurs.

In various embodiments, the padding C may be greater than the padding B, which may be greater than the padding A. For instance, the minimum padding X may be (but not limited to) approximately 5 ms, A may be approximately 5 ms, B may be approximately 10 ms, and C may be approximately 15 ms. Accordingly, the padding X+A may be approximately 10 ms, the padding X+B may be approximately 15 ms, and the padding X+C may be approximately 20 ms. In other embodiments, the padding values (X, A, B, C) may be any suitable value.

As illustrated in Table 1, the padding may increase based on increased complexity of the activities performed by the second RAT on Sub2 197 during the time period used by the control unit 110 to determine the status of the second RAT. The information contained in Table 1 may be stored in the mobile communication device 100, for example, in the storage unit 180 or internal storage of the control unit 110, and may be retrieved by the control unit 110.

One of ordinary skill in the art will appreciate that the RAT status conditions listed in Table 1 are examples and that more, less, and/or different RAT status conditions may exist and may use the same or different padding without departing from the scope of protection. One of ordinary skill in the art will also appreciate that the paddings X, A, B, and C listed in Table 1 are examples and that the same or different paddings may correspond to various RAT status conditions without departing from the scope of protection. In addition, in some embodiments, the inactive state may include some padding (e.g., a value greater than zero but less than X).

Moreover, Table 1 illustrates five different states and their respective padding values. However, in other embodiments, there may any number of states. For example, there could be three states corresponding to inactive, idle, and active each with a respective padding value.

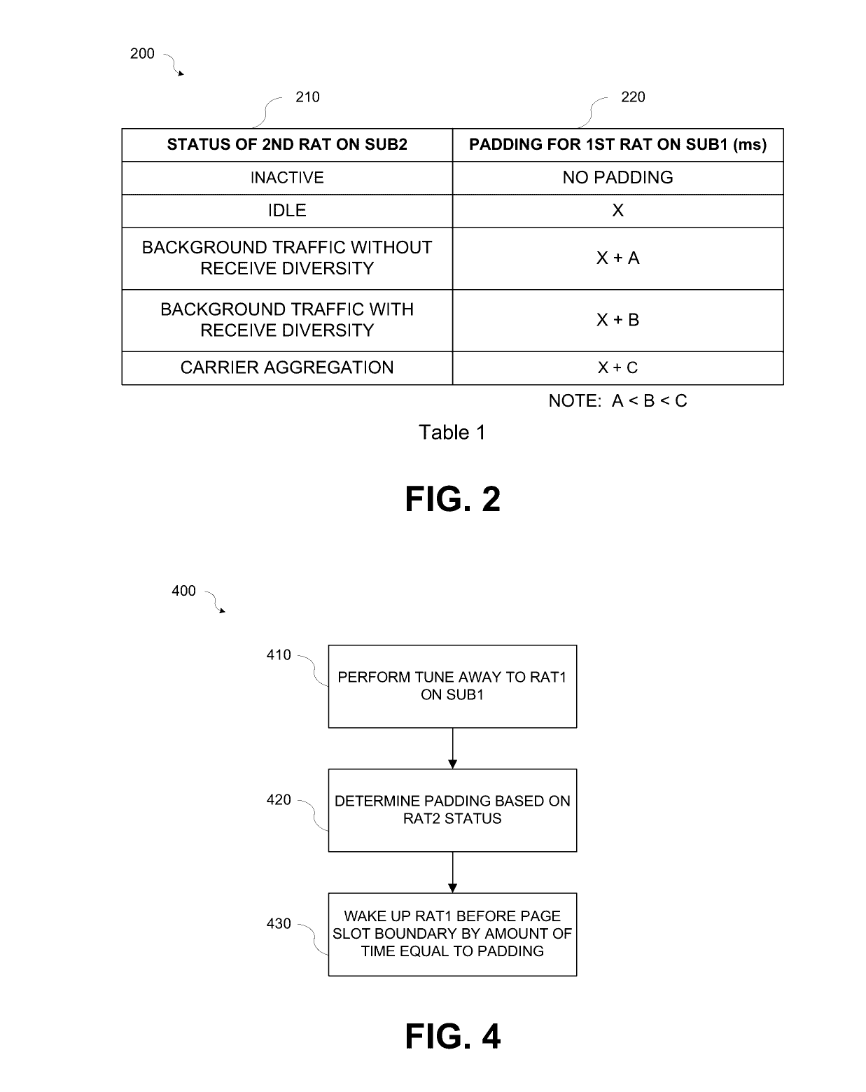

FIG. 3 is a diagram illustrating examples of padding added to wake up time for a RAT according to various embodiments. Referring to FIGS. 1A-3, in sequence 300, during a time period 318a following a tune away period 316a to a first RAT on a first subscription (e.g., Sub1 192), the control unit 110 may determine that a second RAT on a second subscription (e.g., Sub2 197) was in idle mode during the time period 310 before tune away and may transition the first RAT on Sub1 192 to sleep mode. The control unit 110 may configure the communication unit 120 for the second RAT on Sub2 197, and the second RAT on Sub2 197 may again be in idle mode during a time period 325.

Since the control unit 110 determined that the second RAT on Sub2 197 was in idle mode during the previous time period 310, the control unit 110 may add minimum padding X milliseconds 314b to cause the first RAT on Sub1 192 to wake up at 312a X milliseconds before page slot boundary 320a. For example, the control unit 110 may retrieve a padding value corresponding to the status of the first RAT on Sub1 192 from the storage unit 180. The X milliseconds padding may provide additional time for the control unit 110 to reconfigure the communication unit 120 to tune away from the idle mode activities on Sub2 197 before the page slot boundary 320a.

During a time period 318b following a tune away period 316b to the first RAT on Sub1 192, the control unit 110 may determine that the second RAT on Sub2 197 was again in idle mode during the time period 325 before tune away and may transition the first RAT on Sub1 192 to sleep mode. The control unit 110 may configure the communication unit 120 for the second RAT on Sub2 197, and the second RAT on Sub2 197 may be receiving background traffic without using Rx diversity during a time period 330.

With the second RAT on Sub2 197 receiving background traffic without using Rx diversity, more time may be necessary for the control unit 110 to reconfigure the communication unit 120 for tune away to the first RAT on Sub1 192 before page slot boundary 320b from the Sub2 197 activities of receiving background traffic without using Rx diversity. However, since the control unit 110 determined that the second RAT on Sub2 197 was in idle mode during the previous time period 325, the control unit 110 may again add minimum padding X milliseconds 314c. Therefore, the control unit 110 may cause the first RAT on Sub1 192 to wake up at 312b X milliseconds before the page slot boundary 320b.

During a time period 318c following a tune away period 316c to the first RAT on Sub1 192, the control unit 110 may determine that the second RAT on Sub2 197 was receiving background traffic without using Rx diversity during the time period 330 before tune away and may transition the first RAT on Sub1 192 to sleep mode. The control unit 110 may configure the communication unit 120 for the second RAT on Sub2 197, and the second RAT on Sub2 197 may again be receiving background traffic without using Rx diversity during a time period 335.

Since the control unit 110 determined that the second RAT on Sub2 197 was receiving background traffic without using Rx diversity during the previous time period 330, the control unit 110 may add padding X+A milliseconds 336a to cause the first RAT on Sub1 192 to wake up at 338a X+A milliseconds before the page slot boundary 320c. The X+A milliseconds padding may provide additional time for the control unit 110 to reconfigure the communication unit 120 to tune away from the receiving background traffic without using Rx diversity activities on Sub2 197 before the page slot boundary 320c.

During a time period 318d following a tune away period 316d to the first RAT on Sub1 192, the control unit 110 may again determine that the second RAT on Sub2 197 was receiving background traffic without using Rx diversity during time period 335 before tune away and may transition the first RAT on Sub1 192 to sleep mode. The control unit 110 may configure the communication unit 120 for the second RAT on Sub2 197, and the second RAT on Sub2 197 may again be receiving background traffic without using Rx diversity during a time period 340. Based on the determination that the second RAT on Sub2 197 was receiving background traffic without using Rx diversity during the previous time period 335, the control unit 110 may again add padding X+A milliseconds 336b to cause the first RAT on Sub1 192 to wake up at 338b X+A milliseconds before page slot boundary 320d.

During a time period 318e following a tune away period 316e to the first RAT on Sub1 192, the control unit 110 may determine that the second RAT on Sub2 197 was receiving background traffic without using Rx diversity during time period 340 before tune away and may transition the first RAT on Sub1 192 to sleep mode. The control unit 110 may configure the communication unit 120 for the second RAT on Sub2 197, and the second RAT on Sub2 197 may be in idle mode again during a time period 345.

However, since the control unit 110 determined that the second RAT on Sub2 197 was receiving background traffic without using Rx diversity during the previous time period 340, the control unit 110 may still add padding X+A milliseconds 336a to cause the first RAT on Sub1 192 to wake up at 338c X+A milliseconds before page slot boundary 320e even though Sub2 197 is in idle mode. Thus, the control unit 110 may determine the padding for the current wake up of the first RAT on Sub1 192 based on the status of the second RAT on Sub2 197 determined during the previous wakeup of the first RAT on Sub1 192.

Sequence 350 illustrates similar operations of applying padding with the second RAT on Sub2 197 receiving background traffic using Rx diversity. Referring to sequence 350, the control unit 110 may add minimum padding X milliseconds even though the second RAT on Sub2 197 may receive background traffic using Rx diversity during time period 355. Minimum padding X milliseconds may be added since the control unit 110 may determine the padding based on the status of the second RAT on Sub2 197 (i.e., idle during time period 352) determined during time period 354 of the previous wakeup of the first RAT on Sub1 192.

After the time period 360 during which the second RAT on Sub2 197 may again receive background traffic using Rx diversity, the control unit 110 may add padding X+B milliseconds 362a based on a determination of the status of the second RAT on Sub2 197 during the previous time period 355. The control unit 110 may determine the status of the second RAT on Sub2 197 and transition the first RAT on Sub1 192 to the sleep mode during time period 357. The control unit 110 may cause the first RAT on Sub1 192 to wake up at 364a X+B milliseconds before the page slot boundary 320c. Similarly, the control unit 110 may add padding X+B milliseconds 362b based on a determination of the status of the second RAT on Sub2 197 during previous time period 360. Thus, the control unit 110 may cause the first RAT on Sub1 192 to wake up at 364b X+B milliseconds before the page slot boundary 320d.

Sequence 375 illustrates similar operations of applying padding with the second RAT on Sub2 197 communicating with a network (e.g., the first communication network 190 or the second communication network 195) using carrier aggregation. Referring to sequence 375, the control unit 110 may add minimum padding X milliseconds even though the second RAT on Sub2 197 may be using carrier aggregation during time period 380. Minimum padding X milliseconds may be added since the control unit 110 may determine the padding based on the status of the second RAT (i.e., idle during time period 376) on Sub2 197 determined during the time period 378 of the previous wakeup of the first RAT on Sub1 192.

After the time period 385 during which the second RAT on Sub2 197 may again be communicating with the network using carrier aggregation, the control unit 110 may add padding X+C milliseconds 386a based on a determination of the status of the second RAT on Sub2 197 during the previous time period 380. The control unit 110 may determine the status of the second RAT on Sub2 197 and transition the first RAT on Sub1 192 to the sleep mode during time period 382. The control unit 110 may cause the first RAT on Sub1 192 to wake up at 388a X+C milliseconds before the page slot boundary 320c. Similarly, the control unit 110 may add padding X+C milliseconds 386b based on a determination of the status of the second RAT on Sub2 197 during previous time period 385. Thus, the control unit 110 may cause the first RAT on Sub1 192 to wake up at 388b X+C milliseconds before the page slot boundary 320d.

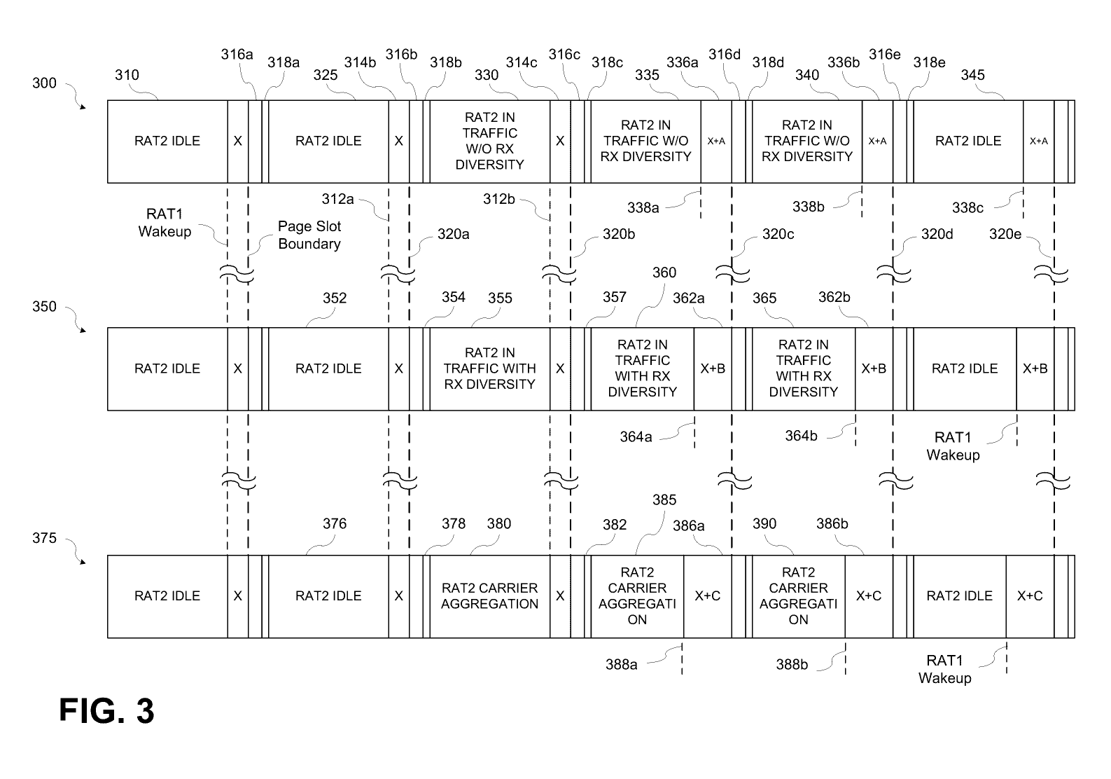

FIG. 4 is a flowchart illustrating a method 400 for applying padding according to various embodiments. Referring to FIGS. 1A-4, at block 410, after the control unit 110 causes the communication unit 120 to perform a tune away, for example, to perform a page decode attempt on a first RAT on a first subscription (e.g., Sub1 192), the control unit 110 may determine a status of a second RAT on a second subscription (e.g., Sub2 197) based on activities performed by the second RAT during a time period before the tune away. For example, the status of the second RAT may be determined based on activities performed by the second RAT during a time period immediately before the tune away or during some other time period before the tune away.

For example, the status of the second RAT may be (but not limited to) inactive (i.e., not camped on a network), idle (i.e., in idle mode), background traffic without receive diversity (i.e., receiving background traffic without using receive diversity), background traffic with receive diversity (i.e., receiving background traffic using receive diversity), carrier aggregation (i.e., communicating with a network (e.g., the first communication network 190 or the second communication network 195) using carrier aggregation), and/or the like. After tune away to the first RAT on Sub1 192 but before the control unit 110 transitions the first RAT on Sub1 192 to sleep mode, the control unit 110 may determine the status of the second RAT on Sub2 197 based on activities performed by the second RAT (e.g., receiving background traffic using receive diversity) prior to the tune away.

At block 420, the control unit 110 may determine the padding based on the status of the second RAT on Sub2 197 determined before the control unit 110 transitioned the first RAT on Sub1 192 to sleep mode. For example, the control unit 110 may retrieve a padding value corresponding to the determined status of the second RAT from the storage unit 180. As such, the control unit 110 may apply the padding determined based on the status of the second RAT on Sub2 197 determined at the previous wakeup of the first RAT to the next wakeup of the first RAT on Sub1 192. Accordingly, at block 430, the control unit 110 may wake up the first RAT on Sub1 192 before the page slot boundary by an amount of time equal to the padding.

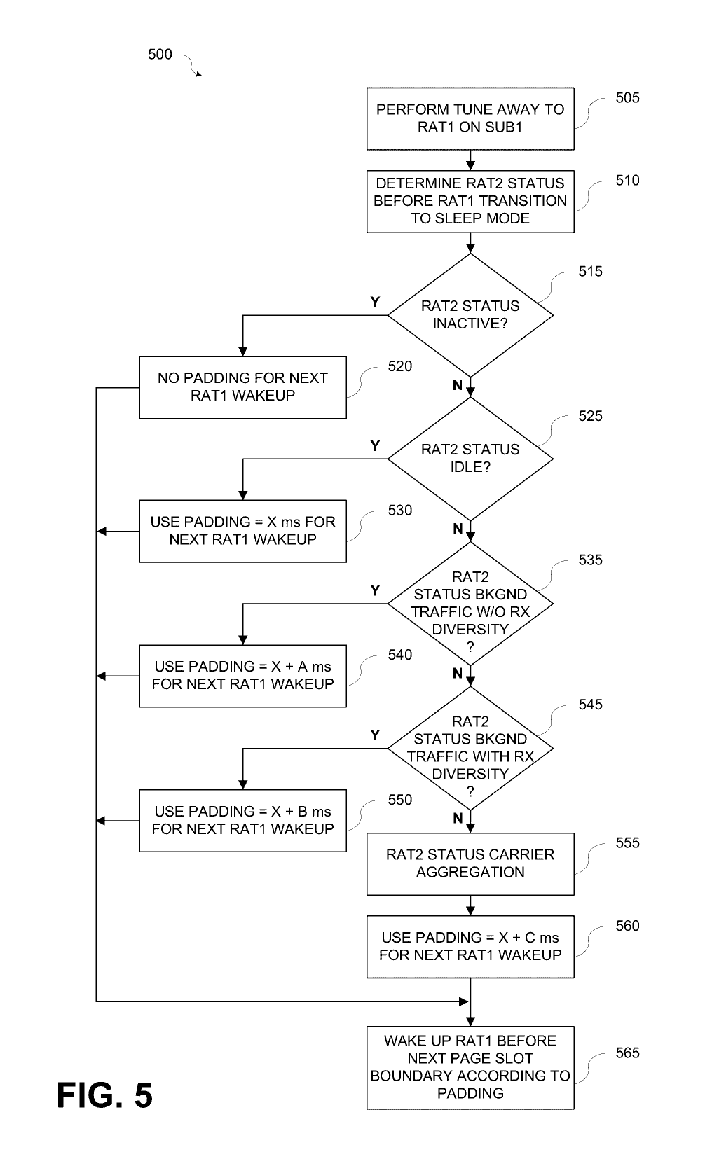

FIG. 5 is a flowchart illustrating a method 500 for determining padding according to various embodiments. Referring to FIGS. 1A-5, at block 505 (which may correspond to block 410), the control unit 110 may cause the communication unit 120 to perform a tune away, for example, to perform a page decode attempt on the first RAT on Sub1 192. At block 510, prior to transitioning the first RAT on Sub1 192 to the sleep mode, the control unit 110 may determine the status of the second RAT on Sub2 197 based on activities of the second RAT before the tune away. For example, the status of the second RAT may be determined based on activities performed by the second RAT during a time period immediately before the tune away or during some other time period before the tune away.

At block 515, the control unit 110 may determine whether the status of the second RAT was inactive (i.e., not camped on a network). In response to determining that the status of the second RAT was inactive (515-Y), at block 520, the control unit 110 may determine not to apply padding for the wakeup of the first RAT on Sub1 192 at the next page slot boundary. For example, the control unit 110 may cause the communication unit 120 to tune away to perform a page decode attempt on the first RAT. After the tune away but before transitioning the first RAT to sleep mode, the control unit 110 may determine the status of the second RAT on Sub2 197 based on activities of the second RAT before the tune away. In response to determining that the status of the second RAT before the tune away was inactive, the control unit 110 may determine that no padding should be used before the wakeup of the first RAT on Sub1 192 at the next page slot boundary.

In response to determining that the status of the second RAT before the tune away was not inactive (515-N), at block 525, the control unit 110 may determine whether the status of the second RAT before the tune away was idle (i.e., idle mode). In response to determining that the status of the second RAT before the tune away was idle (525-Y), at block 530, the control unit 110 may determine to apply padding of X milliseconds at the next wakeup for RAT 1 on Sub1 192. For example, the control unit 110 may retrieve a padding value corresponding to the determined status of the second RAT from the storage unit 180. Therefore, RAT 1 may wake up X milliseconds before the next page slot boundary.

In response to determining that the status of the second RAT before the tune away was not idle (525-N), at block 535, the control unit 110 may determine whether the status of the second RAT before the tune away was “background traffic without receive diversity” (i.e., receiving background traffic without using receive diversity). In response to determining that the status of the second RAT before the tune away was “background traffic without receive diversity” (535-Y), at block 540, the control unit 110 may determine to apply padding of X+A milliseconds at the next wakeup for RAT 1 on Sub1 192. Therefore, RAT 1 may wakeup X+A milliseconds before the next page slot boundary.

In response to determining that the status of the second RAT before the tune away was not “background traffic without receive diversity” (535-N), at block 545, the control unit 110 may determine whether the status of the second RAT before the tune away was “background traffic with receive diversity” (i.e., receiving background traffic using receive diversity). In response to determining that the status of the second RAT before the tune away was “background traffic with receive diversity” (545-Y), at block 550, the control unit 110 may determine to apply padding of X+B milliseconds at the next wakeup for RAT 1 on Sub1 192. Therefore, RAT 1 may wakeup X+B milliseconds before the next page slot boundary.

In response to determining that the status of the second RAT before the tune away was not “background traffic with receive diversity” (545-N), at block 555, the control unit 110 may determine that the status of the second RAT before the tune away was “carrier aggregation” (i.e., communicating with a network (e.g., the first communication network 190 or the second communication network 195) using carrier aggregation). In response to determining that the status of the second RAT before the tune away was “carrier aggregation,” at block 560, the control unit 110 may determine to apply padding of X+C milliseconds at the next wakeup for the first RAT on Sub1 192. Therefore, the first RAT may wakeup X+C milliseconds before the next page slot boundary. As such, one or more of blocks 515-560 may correspond to block 420.

At block 565 (which may correspond to block 430), the control unit 110 may cause the first RAT on Sub1 192 to wake up before the next page slot boundary according to the padding determined by the control unit 110 based on the determined status of the second RAT before the previous tune away.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The methods 400 and 500 may be embodied on a non-transitory computer readable medium, for example, but not limited to, the storage unit 180 or other non-transitory computer readable medium known to those of skill in the art, having stored therein a program including computer executable instructions for making a processor, computer, or other programmable device execute the operations of the methods.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, one discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for providing variable padding for tune away on a mobile communication device, the method comprising:
performing a first tune away to a first radio access technology (RAT) on a first subscription;
determining a status of a second RAT on a second subscription based on activities performed by the second RAT during a time period prior to the first tune away;
determining padding for a second tune away to the first RAT based on the determined status of the second RAT; and causing the first RAT on the first subscription to wake up before a next page slot boundary by an amount of time equal to the padding.

2. The method of claim 1, wherein the determining the status of the second RAT comprises determining the status of the second RAT after the first tune away but prior to transitioning the first RAT to sleep mode.

3. The method of claim 1, wherein the determining the status of the second RAT comprises determining the status of the second RAT based on the activities of the second RAT during a time period immediately before the first tune away.

4. The method of claim 1, wherein the determining the padding for the second tune away comprises:
retrieving a padding value corresponding to the determined status of the second RAT from a table that correlates padding values with statuses of the second RAT.

5. The method of claim 4,
wherein the table is stored in a storage unit on the mobile communication device; and
wherein the padding value is retrieved from the table stored on the mobile communication device.

6. The method of claim 4, wherein the padding values increase based on increased complexity of the activities performed by the second RAT on the second subscription during the time period for which the status of the second RAT is determined.

7. The method of claim 1,
wherein the determining the padding for the second tune away to the first RAT based on the determined status of the second RAT comprises:
in response to determining that the status of the second RAT is a first status, determining a minimum padding for the second tune away to the first RAT; and
wherein the causing the first RAT on the first subscription to wake up before the next page slot boundary by the amount of time equal to the padding comprises:
causing the first RAT on the first subscription to wake up before the next page slot boundary by an amount of time equal to the minimum padding.

8. The method of claim 7,
wherein the determining the padding for the second tune away to the first RAT based on the determined status of the second RAT comprises:
in response to determining that the status of the second RAT is a second status, determining a first additional padding to add to the minimum padding for the next tune away to the first RAT; and
wherein the causing the first RAT on the first subscription to wake up before the next page slot boundary by the amount of time equal to the padding comprises:
causing the first RAT on the first subscription to wake up before the next page slot boundary by an amount of time equal to a sum of the first additional padding and the minimum padding.

9. The method of claim 8,
wherein the determining the padding for the second tune away to the first RAT based on the determined status of the second RAT comprises:
in response to determining that the status of the second RAT is a third status, determining a second additional padding, which is greater than the first additional padding, to add to the minimum padding for the next tune away to the first RAT; and
wherein the causing the first RAT on the first subscription to wake up before the next page slot boundary by the amount of time equal to the padding comprises:
causing the first RAT on the first subscription to wake up before the next page slot boundary by an amount of time equal to a sum of the second additional padding and the minimum padding.

10. The method of claim 9,
wherein the determining the padding for the second tune away to the first RAT based on the determined status of the second RAT comprises:
in response to determining that the status of the second RAT is a fourth status, determining a third additional padding, which is greater than the second additional padding, to add to the minimum padding for the next tune away to the first RAT; and
wherein the causing the first RAT on the first subscription to wake up before the next page slot boundary by the amount of time equal to the padding comprises:
causing the first RAT on the first subscription to wake up before the next page slot boundary by an amount of time equal to a sum of the third additional padding and the minimum padding.

11. A mobile communication device, comprising:
a communication unit configured to communicate with a plurality of communication networks using a plurality of radio access technologies (RATs); and
a control unit configured to:
cause the communication unit to perform a first tune away to a first radio access technology (RAT) on a first subscription;
determine a status of a second RAT on a second subscription based on activities performed by the second RAT during a time period prior to the first tune away;
determine padding for a second tune away to the first RAT based on the determined status of the second RAT; and
cause the first RAT on the first subscription to wake up before a next page slot boundary by an amount of time equal to the padding.

12. The mobile communication device of claim 11, wherein the control unit is further configured to determine the status of the second RAT after the first tune away but prior to transitioning the first RAT to sleep mode.

13. The mobile communication device of claim 11, wherein the control unit is further configured to determine the status of the second RAT based on the activities of the second RAT during the time period immediately before the first tune away.

14. The mobile communication device of claim 11, wherein the control unit is configured to retrieve a padding value corresponding to the determined status of the second RAT from a table that correlates padding values with statuses of the second RAT.

15. The mobile communication device of claim 14, further comprising:
a storage unit for storing the table;
wherein the control unit is configured to retrieve the padding value from the table stored in the storage unit.

16. The mobile communication device of claim 14, wherein the control unit is configured to select an increased padding value based on increased complexity of the activities performed by the second RAT on the second subscription during the time period for which the status of the second RAT is determined.

17. A method for determining padding for tune away on a mobile communication device, the method comprising:
before transitioning a first radio access technology (RAT) to sleep mode after a first tune away, determining a status of a second RAT on a second subscription based on activities performed by the second RAT during a time period prior to the first tune away;
in response to determining that the status of the second RAT is a first status, determining a minimum padding for a second tune away to the first RAT; and
causing the first RAT on the first subscription to wake up before a next page slot boundary by an amount of time equal to the minimum padding.

18. The method of claim 17, wherein the determining the status of the second RAT comprises determining the status of the second RAT based on the activities of the second RAT during the time period immediately before the first tune away.

19. The method of claim 17, further comprising
in response to determining that the status of the second RAT is a second status, determining a first additional padding to add to the minimum padding for the second tune away to the first RAT.

20. The method of claim 19, further comprising
in response to determining that the status of the second RAT is a third status, determining a second additional padding, which is greater than the first additional padding, to add to the minimum padding for the second tune away to the first RAT.

21. The method of claim 20, further comprising
in response to determining that the status of the second RAT is a fourth status, determining a third additional padding, which is greater than the second additional padding, to add to the minimum padding for the second tune away to the first RAT.

22. The method of claim 21, wherein the determining any of the minimum padding, the first additional padding, the second additional padding, and the third additional padding, comprises retrieving a padding value corresponding to the determined status of the second RAT from a table that correlates padding values with statuses of the second RAT.

23. The method of claim 22, wherein the table is stored in a storage unit on the mobile communication device, and
the padding value is retrieved from a table stored on the mobile communication device.

24. A mobile communication device, comprising:
a communication unit configured to communicate with a plurality of communication networks using a plurality of radio access technologies (RATs); and
a control unit configured to:
before transitioning a first radio access technology (RAT) to sleep mode after a first tune away, determine a status of a second RAT on a second subscription based on activities performed by the second RAT during a time period prior to the first tune away;
in response to determining that the status of the second RAT is a first status, determine a minimum padding for a second tune away to the first RAT; and
cause the first RAT on the first subscription to wake up before a next page slot boundary by an amount of time equal to the minimum padding.

25. The mobile communication device of claim 24, wherein the control unit is further configured to
determine the status of the second RAT based on the activities of the second RAT during the time period immediately before the first tune away.

26. The mobile communication device of claim 24, wherein
in response to determining that the status of the second RAT is a second status, the control unit is configured to determine a first additional padding to add to the minimum padding for the second tune away to the first RAT.

27. The mobile communication device of claim 26, wherein
in response to determining that the status of the second RAT is a third status, the control unit is configured to determine a second additional padding greater than the first additional padding to add to the minimum padding for the second tune away to the first RAT.

28. The mobile communication device of claim 27, wherein
in response to determining that the status of the second RAT is a fourth status, the control unit is configured to determine a third additional padding greater than the second additional padding to add to the minimum padding for the second tune away to the first RAT.
